(19) United States
(12) Patent Application Publication
(10) Pub. No.: US 2017/0361299 A1
(43) Pub. Date: Dec. 21, 2017

(54) METHODS AND DEVICES FOR THE PREPARATION OF NANOMATERIALS

(71) Applicant: OHIO STATE INNOVATION FOUNDATION, Columbus, OH (US)

(72) Inventors: Nicholas Brunelli, Columbus, OH (US); Aamena Parulkar, Columbus, OH (US)

(21) Appl. No.: 15/627,046

(22) Filed: Jun. 19, 2017

Related U.S. Application Data
(60) Provisional application No. 62/351,603, filed on Jun. 17, 2016.

(51) Int. Cl. B01J 19/06; B01J 14/00; C07F 3/06; C07F 19/00

(52) U.S. Cl. CPC B01J 19/06; C07F 19/005; B01J 14/00; C07F 3/06

(57) ABSTRACT

Disclosed herein are methods for preparing nanomaterials, such as nanoparticles. The methods can involve jet-mixing two or more precursor solutions to form the nanomaterials. By rapidly mixing the precursor solutions, nanomaterials of improved quality and uniformity can be prepared in high yield (e.g., in yields of at least 85%). The methods are also scalable, and allow for the continuous production of nanomaterials. Also provided are jet-mixing reactors that can be used to prepare nanomaterials using the methods described herein.

### CROSS REFERENCE TO RELATED APPLICATIONS

This application claims the benefit of U.S. Provisional Application No. 62/351,603, filed Jun. 17, 2016, the disclosure of which is expressly incorporated herein by reference.

### BACKGROUND

Nanomaterials are of intense interest for various applications, including applications in the biomedical, energy, catalysis, cosmetics, food, electronics, and semiconductor industries. The physiochemical properties of nanomaterials (e.g., composition, size, shape, size distribution, and surface functionality) can be controllable to meet the demands of a wide variety of end use applications. While promising for many applications, nanomaterials often must be synthesized using time consuming and/or inefficient processes. Improved methods for the production of nanomaterials are needed to provide more economical sources of high quality nanomaterials.

### SUMMARY

Provided herein are methods for preparing nanomaterials, such as nanoparticles. The methods can involve jet-mixing two or more precursor solutions to form the nanomaterials. By rapidly mixing the precursor solutions, nanomaterials of improved quality and uniformity can be prepared in high yield (e.g., in yields of at least 70%, at least 75%, at least 80%, at least 85%, or at least 90%). The methods are also scalable, and allow for the continuous production of nanomaterials.

Methods for preparing nanomaterials, including nanoparticles, can comprise directing a stream of a first precursor solution through a mixing chamber, wherein the stream flows through a mixing chamber along an axis of fluid flow stretching from an inlet jet to an outlet port; and directing a plurality of mixing streams to impinge upon the stream of the first precursor solution within the mixing chamber, wherein each of the plurality of mixing streams comprises a second precursor solution, thereby mixing the first precursor solution and the second precursor solution to form the population of nanoparticles. Methods can further include collecting the population of nanoparticles from the outlet port.

Each of the plurality of mixing streams can be directed from a mixing jet to impinge the stream of the first precursor solution as it flows through the mixing chamber. The mixing jets can be circumferentially disposed about the axis of fluid flow. In some cases, the mixing jets can be equally spaced circumferentially about the axis of fluid flow. In some of these embodiments, the mixing streams can be radially symmetrical with respect to the axis of fluid flow. In certain embodiments, the mixing jets can be radially spaced from the stream of the first precursor solution, and disposed within a plane perpendicular to the axis of fluid flow.

The angle at which a mixing stream impinges the stream of the first precursor solution (referred to herein as the incidence angle, and defined as the angle between the axis of fluid flow and the axis along which the mixing stream is directed) can vary. In some embodiments, each of the plurality of mixing streams can impinge upon the stream of the first precursor solution at an incidence angle of from 45 degrees to 135 degrees (e.g., from 45 degrees to 90 degrees). Each of the plurality of mixing streams can independently be directed to impinge the stream of the first precursor solution at any suitable angle. In some embodiments, each of the plurality of mixing streams impinges the stream of the first precursor solution at substantially the same incidence angle. In certain embodiments, each of the plurality of mixing streams is directed substantially perpendicular to the stream of the first precursor solution (i.e., each of the plurality of mixing streams impinges upon the stream of the first precursor solution at an incidence angle of 90 degrees±5 degrees). Any suitable number of mixing streams can be directed to impinge the stream of the first precursor solution as it flows through the mixing chamber. For example, the plurality of mixing streams can comprise from two to eight mixing streams.

The plurality of mixing streams can be directed to impinge the stream of the first precursor solution so as to rapidly mix the first precursor solution and the second precursor solution. In some embodiments, mixing of the first precursor solution and the second precursor solution can comprise turbulent mixing. In certain embodiments, mixing of the first precursor solution and the second precursor solution can comprise mixing at a Reynolds number of at least 500 (e.g., at least 1000, at least 1500, at least 2000, at least 2500, at least 3000, at least 4000, or at least 5000).

The first precursor solution and the second precursor solution can include components which react upon combination in the mixing chamber to form the population of nanoparticles. The components of the first precursor solution and the second precursor solution will thus vary, and can be selected based on the type of nanoparticles to be prepared. For example, the first precursor solution, the second precursor solution, or a combination thereof can include a variety of components, such as metal salts, reducing agents, ligands, capping agents, polymers, surfactants, solvents, and combinations thereof. By way of example, in one embodiment, the population of nanoparticles prepared by the methods described herein can comprise nanoparticles formed from a metal organic framework (MOF), such as a zeolitic imidazolate framework (e.g., ZIF-8 nanoparticles). In these cases, the first precursor solution can comprise, for example, a metal salt, and the second precursor solution can comprise, for example, a ligand.

The methods described herein can provide improved control over the particle size and/or particle size distribution of nanoparticles. In some embodiments, the population of nanoparticles can have an average particle size of less than 250 nm (e.g., less than 200 nm, or less than 100 nm). In certain embodiments, the population of nanoparticles can have an average particle size of from 40 nm to 80 nm. In certain embodiments, the population of nanoparticles is monodisperse.

If desired for a particular application, additional mixing streams can be directed to impinge upon the stream of the first precursor solution and second precursor solution within the mixing chamber. For example, methods can further comprise directing a second plurality of fluid streams to impinge upon the stream of the first precursor solution and second precursor solution within the mixing chamber. The second plurality of mixing streams can be downstream and axially spaced apart from the first plurality of mixing streams.

As with the first plurality of mixing streams described above, each of the second plurality of mixing streams can be directed from a mixing jet to impinge the stream of the first precursor solution and second precursor solution as it flows through the mixing chamber. The mixing jets can be circumferentially disposed about the axis of fluid flow. In some cases, the mixing jets can be equally spaced circumferentially about the axis of fluid flow. In some of these embodiments, the mixing streams can be radially symmetrical with respect to the axis of fluid flow. In certain embodiments, the mixing jets can be radially spaced from the stream of the first precursor solution and second precursor solution, and disposed within a plane perpendicular to the axis of fluid flow.

In some embodiments, each of the second plurality of mixing streams can impinge upon the stream of the first precursor solution and second precursor solution at an incidence angle of from 45 degrees to 135 degrees (e.g., from 45 degrees to 90 degrees). Each of the second plurality of mixing streams can independently be directed to impinge the stream of the first precursor solution and second precursor solution at any suitable angle. In some embodiments, each of the second plurality of mixing streams impinges the stream of the first precursor solution and second precursor solution at substantially the same incidence angle. In certain embodiments, each of the second plurality of mixing streams is directed substantially perpendicular to the stream of the first precursor solution and second precursor solution (i.e., each of the second plurality of mixing streams impinges upon the stream of the first precursor solution and second precursor solution at an incidence angle of 90°±5°). Any suitable number of mixing streams can be directed to impinge the stream of the first precursor solution and second precursor solution as it flows through the mixing chamber. For example, the second plurality of mixing streams can comprise from two to eight mixing streams.

In some embodiments, each of the second plurality of mixing streams can comprise a third precursor solution. The third precursor solution can include components which react upon combination with the first precursor solution and second precursor solution to form the population of nanoparticles. Using such methods, a wider range of nanoparticles can be prepared. For example, additional reactants can be added to the components present in the first precursor solution and second precursor solution to form, for example, ternary nanoparticles and quaternary nanoparticles, such as CIGS and CIS nanoparticles (copper indium gallium di-selenide/sulfide, copper indium di-selenide/sulfide), and CZTS nanoparticles (copper zinc tin selenide/sulfide). Alternatively, the third precursor solution can include components that modify nanoparticles formed by mixing of the first precursor solution and second precursor solution. In this way, core-shell nanomaterials can be prepared using the methods described herein. In other embodiments, each of the second plurality of mixing streams can comprise a solvent that is added to dilute the nanoparticles formed by mixing of the first precursor solution and second precursor solution (e.g., to prevent nanoparticle aggregation).

Also provided herein are jet-mixing reactors for the preparation of nanomaterials. The jet-mixing reactors can comprise a mixing chamber defining an axial path for fluid flow from an inlet jet to an outlet port; and a plurality of mixing jets circumferentially disposed about the axial path for fluid flow within the mixing chamber. Each of the plurality of mixing jets is configured to direct a stream of fluid to impinge upon the axial path for fluid flow.

The mixing jets can be equally spaced circumferentially about the axial path for fluid flow. In some embodiments, the mixing jets can be radially spaced from the axial path for fluid flow and disposed within a plane perpendicular to the axial path for fluid flow. Each of the plurality of mixing jets can be configured to direct a stream of fluid to impinge upon the axial path for fluid flow at an incidence angle of from 45 degrees to 135 degrees (e.g., from 45 degrees to 90 degrees). In certain embodiments, each of the plurality of mixing jets can be configured to direct a stream of fluid substantially perpendicular to the axial path for fluid flow (i.e., each of the plurality of mixing jets can be configured to direct a stream of fluid to impinge upon the axial path for fluid flow at an incidence angle of 90°±5°). The plurality of mixing jets can include any suitable number of mixing jets. For example, the plurality of mixing jets can comprise from two to eight mixing jets.

In some embodiments, the reactor can further comprise a second plurality of mixing jets circumferentially disposed about the axial path for fluid flow within the mixing chamber. The second plurality of mixing jets can be disposed downstream and axially spaced apart from the first plurality of mixing jets. Each of the second plurality of mixing jets can be configured to direct a stream of fluid to impinge upon the axial path for fluid flow.

As with the first plurality of mixing jets, the second plurality of mixing jets can be equally spaced circumferentially about the axial path for fluid flow. In some embodiments, the second plurality of mixing jets can be radially spaced from the axial path for fluid flow and disposed within a plane perpendicular to the axial path for fluid flow. Each of the second plurality of mixing jets can be configured to direct a stream of fluid to impinge upon the axial path for fluid flow at an incidence angle of from 45 degrees to 135 degrees (e.g., from 45 degrees to 90 degrees). In certain embodiments, each of the second plurality of mixing jets can be configured to direct a stream of fluid substantially perpendicular to the axial path for fluid flow (i.e., each of the plurality of mixing jets can be configured to direct a stream of fluid to impinge upon the axial path for fluid flow at an incidence angle of 90°±5°). The second plurality of mixing jets can include any suitable number of mixing jets. For example, the second plurality of mixing jets can comprise from two to eight mixing jets.

### DESCRIPTION OF DRAWINGS

FIG. 1 is a schematic illustration of an example jet-mixing reactor. Left: Reactor design with dⱼ=jet inlet diameter and dr main through-line diameter (dᵣ/dⱼ=2). Right: Schematic illustration of the fluid flow pattern in the example jet-mixing reactor: a metal solution is injected through the main line, ligand through the jet inlets, and the product suspension is collected downstream.

FIG. 2 includes SEM images of samples JM-1 to JM-3 comparing ZIF-8 using (panel a) JM-1, L:M:B=2:1:0 (255±62 nm), (panel b) JM-2, L:M:B=2:1:1 (63±9 nm), and (panel c) JM-3, 2:1:2 (57±8 nm), The morphology changed from rhombic dodecahedron to rounded berry-like particles when the base was added. All images were obtained at 1 μm magnification. Reaction was done using small JM reactor, Qⱼ=10 mL/h, Qᵣ=5 mL/h, and Zn(NO₃).5H₂O concentration=10 mM.

FIG. 3 includes SEM images for comparing ZIF-8 synthesized using (panel a) JM-4-0h, jet-mixing (74±15 nm), (panel b) D-1-0h, dropwise addition (104±43 nm), and (panel c) B-1-0h, bulk addition. As the mixing intensity decreased from jet-mixing to bulk addition, the particle aggregation increased. ZIF-8 was synthesized under different mixing conditions while keeping the other parameters constant: L:M:B=2:1:2, Qⱼ/Qᵣ=10/10 mL/h, jet mixing reactor 0.013″/0.02″.

FIG. 4 shows an SEM image of particles of ZIF-8 prepared by jet-mixing synthesis in acetone (JM-7). The particles exhibited a particle size of 60±15 nm. The reaction was done using a small JM reactor (0.01″/0.02″), Qj=Qr=10 mL/h, L:M:B=2:1:2, and Zn concentration=10 mM.

FIG. 5 includes SEM images for jet-mixing synthesis of (panel a) ZIF-67 (JM-15) and (panel b) ZIF-8 (JM-12). The particle size was larger for ZIF-67 as compared to ZIF-8 (˜80 nm) synthesized under the same conditions.

FIG. 6 illustrates a method for synthesizing ZIF-8 nanoparticles using the jet-mixing reactors described herein.

FIG. 7 is a schematic illustration of a fluid flow pattern for preparing a nanomaterial using the jet-mixing methods and reactors described herein. The method includes mixing four precursor solutions in parallel to form a first intermediate solution and a second intermediate solution, and then jet-mixing the first intermediate solution and the second intermediate solution to form a nanomaterial.

FIG. 8 is a schematic illustration showing a cross-sectional view of an example jet-mixing reactor.

FIG. 9 is a schematic illustration showing a 3-dimensional and cross-sectional views of an example jet-mixing reactor.

FIG. 10 is a schematic illustration showing a 3-dimensional and cross-sectional views of an example jet-mixing reactor.

FIG. 11 is a schematic illustration showing a cross-sectional view of an example jet-mixing reactor.

FIG. 12 is a schematic illustration showing a 3-dimensional and cross-sectional views of an example jet-mixing reactor.

### DETAILED DESCRIPTION

General Definitions

“Monodisperse” and “homogeneous size distribution,” as used herein, and generally describe a population of particles where all of the particles are the same or nearly the same size. As used herein, a monodisperse distribution refers to particle distributions in which 80% of the distribution (e.g., 85% of the distribution, 90% of the distribution, or 95% of the distribution) lies within 25% of the median particle size (e.g., within 20% of the median particle size, within 15% of the median particle size, within 10% of the median particle size, or within 5% of the median particle size).

“Mean particle size” or “average particle size”, are used interchangeably herein, and generally refer to the statistical mean particle size of the particles in a population of nanoparticles. The diameter of an essentially spherical particle can refer to the physical diameter of the spherical particle. The diameter of a non-spherical nanoparticle can refer to the largest linear distance between two points on the surface of the nanoparticle. Mean particle size can be measured using methods known in the art, such as evaluation by scanning electron microscopy.

Methods

Provided herein are methods for preparing nanomaterials, such as nanoparticles. The methods can involve jet-mixing two or more precursor solutions to form the nanomaterials. By rapidly mixing the precursor solutions, nanomaterials of improved quality and uniformity can be prepared in high yield (e.g., in yields of at least 70%, at least 75%, at least 80%, at least 85%, or at least 90%). The methods are also scalable, and allow for the continuous production of nanomaterials.

Methods for preparing nanomaterials, including nanoparticles, can comprise directing a stream of a first precursor solution through a mixing chamber, wherein the stream flows through a mixing chamber along an axis of fluid flow stretching from an inlet jet to an outlet port; and directing a plurality of mixing streams to impinge upon the stream of the first precursor solution within the mixing chamber, wherein each of the plurality of mixing streams comprises a second precursor solution, thereby mixing the first precursor solution and the second precursor solution to form the population of nanoparticles. Methods can further include collecting the population of nanoparticles from the outlet port.

Each of the plurality of mixing streams can be directed from a mixing jet to impinge the stream of the first precursor solution as it flows through the mixing chamber. The mixing jets can be circumferentially disposed about the axis of fluid flow. In some cases, the mixing jets can be equally spaced circumferentially about the axis of fluid flow. In some of these embodiments, the mixing streams can be radially symmetrical with respect to the axis of fluid flow. In certain embodiments, the mixing jets can be radially spaced from the stream of the first precursor solution, and disposed within a plane perpendicular to the axis of fluid flow.

The angle at which a mixing stream impinges the stream of the first precursor solution (referred to herein as the incidence angle, and defined as the angle between the axis of fluid flow and the axis along which the mixing stream is directed) can vary. In some embodiments, each of the plurality of mixing streams can impinge upon the stream of the first precursor solution at an incidence angle of from 45 degrees to 135 degrees (e.g., from 45 degrees to 90 degrees). Each of the plurality of mixing streams can independently be directed to impinge the stream of the first precursor solution at any suitable angle. In some embodiments, each of the plurality of mixing streams impinges the stream of the first precursor solution at substantially the same incidence angle. In certain embodiments, each of the plurality of mixing streams is directed substantially perpendicular to the stream of the first precursor solution (i.e., each of the plurality of mixing streams impinges upon the stream of the first precursor solution at an incidence angle of 90°±5°). Any suitable number of mixing streams can be directed to impinge the stream of the first precursor solution as it flows through the mixing chamber. For example, the plurality of mixing streams can comprise from two to eight mixing streams (e.g., from three to eight mixing streams, from two to six mixing streams, from three to six mixing streams, or from two to four mixing streams).

The plurality of mixing streams can be directed to impinge the stream of the first precursor solution so as to rapidly mix the first precursor solution and the second precursor solution. In some embodiments, mixing of the first precursor solution and the second precursor solution can comprise turbulent mixing. In certain embodiments, mixing of the first precursor solution and the second precursor solution can comprise mixing at a Reynolds number of at least 500 (e.g., at least 1000, at least 1500, at least 2000, at least 2500, at least 3000, at least 4000, or at least 5000). In other embodiments, mixing of the first precursor solution and the second precursor solution can comprise mixing at a Reynolds number of at least 5000 (e.g., at least 6000, at least 7000, at least 8000, at least 9000, at least 10000, at least 12500, or at least 15000). Mixing of the first precursor solution and the second precursor solution can comprise mixing at a Reynolds number ranging between any of the values described above (e.g., mixing at a Reynolds number of from 500 to 15000, or mixing at a Reynolds number of from 2000 to 15000).

The first precursor solution and the second precursor solution can include components which react upon combination in the mixing chamber to form the population of nanoparticles. The components of the first precursor solution and the second precursor solution will thus vary, and can be selected based on the type of nanoparticles to be prepared. For example, the first precursor solution, the second precursor solution, or a combination thereof can include a variety of components, such as metal salts, reducing agents, ligands, capping agents, polymers, surfactants, solvents, and combinations thereof. By way of example, in one embodiment, the population of nanoparticles prepared by the methods described herein can comprise nanoparticles formed from a metal organic framework (MOF), such as a zeolitic imidazolate framework (e.g., ZIF-8 nanoparticles). In these cases, the first precursor solution can comprise, for example, a metal salt, and the second precursor solution can comprise, for example, a ligand.

The methods described herein can provide improved control over the particle size and/or particle size distribution of nanoparticles. In some embodiments, the population of nanoparticles can have an average particle size, as measured by SEM, of 250 nm or less (e.g., 200 nm or less, 150 nm or less, 100 nm or less, 95 nm or less, 90 nm or less, 85 nm or less, 80 nm or less, 75 nm or less, 70 nm or less, 65 nm or less, 60 nm or less, 55 nm or less, 50 nm or less, 45 nm or less, 40 nm or less, 35 nm or less, 30 nm or less, 25 nm or less, 20 nm or less, or 15 nm or less). In some embodiments, the population of nanoparticles can have an average particle size, as measured by scanning electron microscopy (SEM), of at least 10 nm (e.g., at least 15 nm, at least 20 nm, at least 25 nm, at least 30 nm, at least 35 nm, at least 40 nm, at least 45 nm, at least 50 nm, at least 55 nm, at least 60 nm, at least 65 nm, at least 70 nm, at least 75 nm, at least 80 nm, at least 85 nm, at least 90 nm, at least 95 nm, at least 100 nm, at least 150 nm, or at least 200 nm).

The population of nanoparticles can have an average particle size, as measured by SEM, ranging from any of the minimum values described above to any of the maximum values described above. For example, the population of nanoparticles can have can have an average particle size, as measured by SEM, of from 10 nm to 250 nm (e.g., from 10 nm to 200 nm, from 10 nm to 100 nm, from 20 nm to 100 nm, or from 40 nm to 80 nm). In certain embodiments, the population of nanoparticles can be monodisperse in size.

If desired for a particular application, methods can further comprise heating, cooling, or combinations thereof during the course of nanomaterial synthesis. Heating and/or cooling can be accomplished via any suitable method known in the art. In some cases, heating and/or cooling can comprise heating or cooling the first precursor solution prior, the second precursor solution, or a combination thereof before introducing the fluid streams into the mixing chamber. In some cases, heating and/or cooling can comprise heating or cooling the inlet jet through which the first precursor solution is introduced into the mixing chamber. In other cases, heating and/or cooling can comprise heating or cooling the mixing jets through which the second precursor solution is introduced into the mixing chamber. In some cases, heating and/or cooling can comprise heating or cooling the mixing chamber. In some cases, heating and/or cooling can comprise heating or cooling the outlet port.

If desired for a particular application, additional mixing streams can be directed to impinge upon the stream of the first precursor solution and second precursor solution within the mixing chamber. For example, methods can further comprise directing a second plurality of fluid streams to impinge upon the stream of the first precursor solution and second precursor solution within the mixing chamber. The second plurality of mixing streams can be downstream and axially spaced apart from the first plurality of mixing streams.

As with the first plurality of mixing streams described above, each of the second plurality of mixing streams can be directed from a mixing jet to impinge the stream of the first precursor solution and second precursor solution as it flows through the mixing chamber. The mixing jets can be circumferentially disposed about the axis of fluid flow. In some cases, the mixing jets can be equally spaced circumferentially about the axis of fluid flow. In some of these embodiments, the mixing streams can be radially symmetrical with respect to the axis of fluid flow. In certain embodiments, the mixing jets can be radially spaced from the stream of the first precursor solution and second precursor solution, and disposed within a plane perpendicular to the axis of fluid flow.

In some embodiments, each of the second plurality of mixing streams can impinge upon the stream of the first precursor solution and second precursor solution at an incidence angle of from 45 degrees to 135 degrees (e.g., from 45 degrees to 90 degrees). Each of the second plurality of mixing streams can independently be directed to impinge the stream of the first precursor solution and second precursor solution at any suitable angle. In some embodiments, each of the second plurality of mixing streams impinges the stream of the first precursor solution and second precursor solution at substantially the same incidence angle. In certain embodiments, each of the second plurality of mixing streams is directed substantially perpendicular to the stream of the first precursor solution and second precursor solution (i.e., each of the second plurality of mixing streams impinges upon the stream of the first precursor solution and second precursor solution at an incidence angle of 90°±5°). Any suitable number of mixing streams can be directed to impinge the stream of the first precursor solution and second precursor solution as it flows through the mixing chamber. For example, the second plurality of mixing streams can comprise from two to eight mixing streams (e.g., from three to eight mixing streams, from two to six mixing streams, from three to six mixing streams, or from two to four mixing streams).

In some embodiments, each of the second plurality of mixing streams can comprise a third precursor solution. The third precursor solution can include components which react upon combination with the first precursor solution and second precursor solution to form the population of nanoparticles. Using such methods, a wider range of nanoparticles can be prepared. For example, additional reactants can be added to the components present in the first precursor solution and second precursor solution to form, for example, ternary nanoparticles and quaternary nanoparticles, such as CIGS and CIS nanoparticles (copper indium gallium di-selenide/sulfide, copper indium di-selenide/sulfide), and CZTS nanoparticles (copper zinc tin selenide/sulfide). Alternatively, the third precursor solution can include components that modify nanoparticles formed by mixing of the first precursor solution and second precursor solution. In this way, core-shell nanomaterials can be prepared using the methods described herein. In other embodiments, each of the second plurality of mixing streams can comprise a solvent that is added to dilute the nanoparticles formed by mixing of the first precursor solution and second precursor solution (e.g., to prevent nanoparticle aggregation).

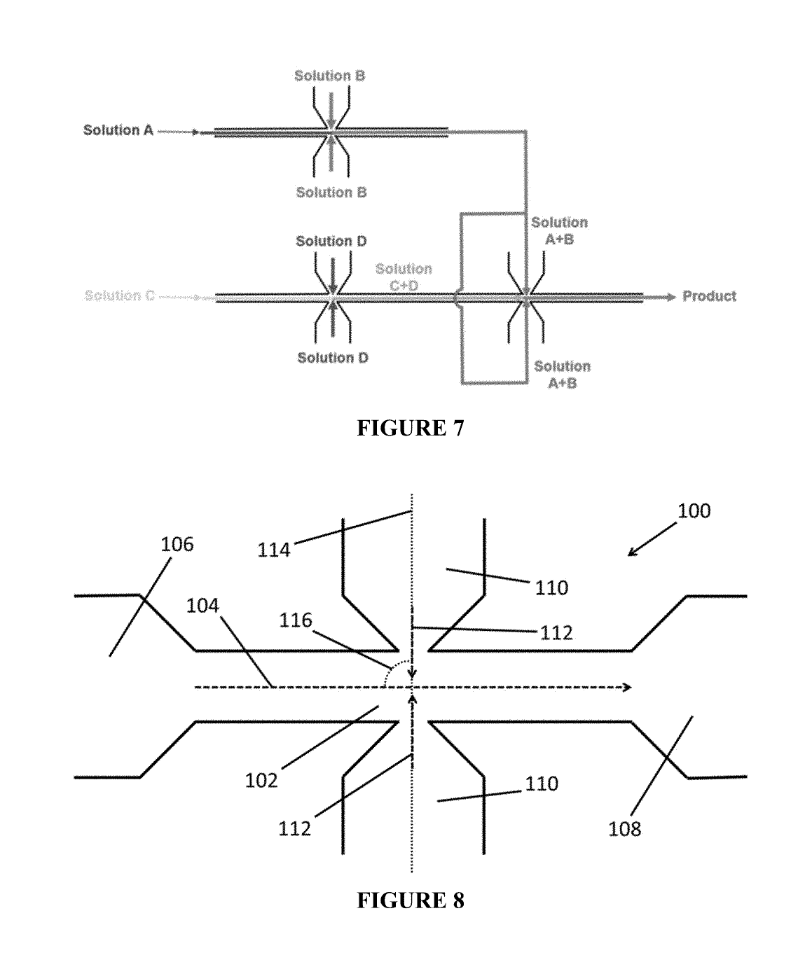

In some embodiments, methods for preparing nanomaterials can comprise jet-mixing a plurality of precursor solutions in parallel to form at least a first intermediate solution and a second intermediate solution, and then jet-mixing the first intermediate solution and the second intermediate solution to form the nanomaterials. By way of example, referring now to FIG. 7, in some embodiments, methods can comprise directing a stream of a first precursor solution (solution A) through a mixing chamber, wherein the stream flows through a mixing chamber along an axis of fluid flow stretching from an inlet jet to an outlet port; and directing a plurality of mixing streams to impinge upon the stream of the first precursor solution within the mixing chamber, wherein each of the plurality of mixing streams comprises a second precursor solution (solution B), thereby mixing the first precursor solution and the second precursor solution to form a first intermediate solution (solution A+B). In parallel, a stream of a third precursor solution (solution C) can be directed through a mixing chamber, wherein the stream flows through a mixing chamber along an axis of fluid flow stretching from an inlet jet to an outlet port; and directing a plurality of mixing streams to impinge upon the stream of the third precursor solution within the mixing chamber, wherein each of the plurality of mixing streams comprises a fourth precursor solution (solution D), thereby mixing the third precursor solution and the fourth precursor solution to form a second intermediate solution (solution C+D). Subsequently, methods can comprise directing a stream of the second intermediate solution (solution C+D) through a mixing chamber, wherein the stream flows through a mixing chamber along an axis of fluid flow stretching from an inlet jet to an outlet port; and directing a plurality of mixing streams to impinge upon the stream of the second intermediate solution within the mixing chamber, wherein each of the plurality of mixing streams comprises the first intermediate solution (solution A+B), thereby mixing the first intermediate solution and the second intermediate solution to form a nanomaterial. Methods can further include collecting the nanomaterial (e.g., a population of nanoparticles) from the outlet port.

Reactors

Also provided herein are jet-mixing reactors for the preparation of nanomaterials. Referring now to FIG. 8, the jet-mixing reactors (100) can comprise a mixing chamber (102) defining an axial path for fluid flow (104) from an inlet jet (106) to an outlet port (108); and a plurality of mixing jets (110) circumferentially disposed about the axial path for fluid flow within the mixing chamber. Each of the plurality of mixing jets is configured to direct a stream of fluid (112) to impinge upon the axial path for fluid flow.

The mixing jets can equally spaced circumferentially about the axial path for fluid flow. In some embodiments, the mixing jets can be radially spaced from the axial path for fluid flow and disposed within a plane perpendicular to the axial path for fluid flow (114). Each of the plurality of mixing jets can be configured to direct a stream of fluid to impinge upon the axial path for fluid flow at an incidence angle (116) of from 45 degrees to 135 degrees (e.g., from 45 degrees to 90 degrees). In certain embodiments, each of the plurality of mixing jets can be configured to direct a stream of fluid substantially perpendicular to the axial path for fluid flow (i.e., each of the plurality of mixing jets can be configured to direct a stream of fluid to impinge upon the axial path for fluid flow at an incidence angle of 90°±5°). The plurality of mixing jets can include any suitable number of mixing jets. For example, the plurality of mixing jets can comprise from two to eight mixing jets (e.g., from three to eight mixing jets, from two to six mixing jets, from three to six mixing jets, or from two to four mixing jets).

In some embodiments, the mixing chamber can have a circular or ovoid cross section. In some embodiments, the inlet jet can have a circular or ovoid cross section which tapers in a conular fashion to intersect the mixing chamber. In some embodiments, the taper can narrow a diameter of the inlet jet by at least 10% (e.g., at least 20%, at least 25%, at least 30%, at least 40%, at least 50%, at least 60%, at least 70%, at least 75%, at least 80%, or at least 90%) from the diameter at the inlet jet's widest point to the diameter at the point where the inlet jet intersects the mixing channel. In some embodiments, the mixing jets can have a circular or ovoid cross section which tapers in a conular fashion to intersect the mixing chamber. In some embodiments, the mixing jets can have a circular or ovoid cross section which tapers in a conular fashion to intersect the mixing chamber. In some embodiments, the taper can narrow a diameter of the mixing jets by at least 10% (e.g., at least 20%, at least 25%, at least 30%, at least 40%, at least 50%, at least 60%, at least 70%, at least 75%, at least 80%, or at least 90%) from the diameter at the mixing jets' widest point to the diameter at the point where the mixing jets intersect the mixing channel. In some embodiments, the outlet port can have a circular or ovoid cross section.

In some embodiments, the mixing chamber, the inlet jet, the mixing jets, the outlet jet, or a combination thereof are formed from a material having a melting temperature and/or glass transition temperature of at least 120° C. (e.g., at least 130° C., at least 140° C., at least 150° C., at least 160° C., at least 170° C., at least 180° C., at least 190° C., or at least 200° C.). This can allow the jet-mixing reactor to be used to synthesize nanomaterials at high temperatures. In some embodiments, the mixing chamber, the inlet jet, the mixing jets, the outlet jet, or a combination thereof can be formed from a polymeric material (e.g., a thermoplastic such as polyether ether ketone). In some embodiments, the mixing chamber, the inlet jet, the mixing jets, the outlet jet, or a combination thereof can be formed from glass, metal, or a combination thereof.

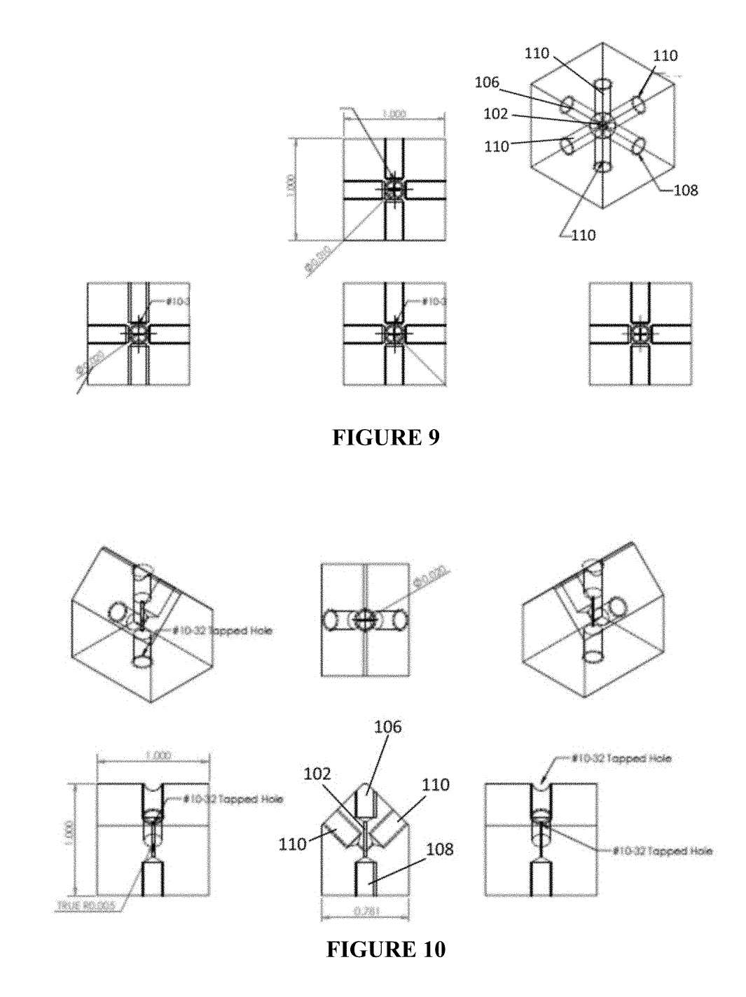

By way of a further example, FIG. 9 illustrates an example jet-mixing reactor that comprises a mixing chamber (102) defining an axial path for fluid flow from an inlet jet (106) to an outlet port (108); and four mixing jets (110) circumferentially disposed about the axial path for fluid flow within the mixing chamber. Each of the four mixing jets is configured to direct a stream of fluid to impinge upon the axial path for fluid flow. The four mixing jets are equally spaced circumferentially about the axial path for fluid flow. In this case, the four mixing jets are radially spaced from the axial path for fluid flow and disposed within a plane perpendicular to the axial path for fluid flow. Each of the four mixing jets is configured to direct a stream of fluid substantially perpendicular to the axial path for fluid flow (i.e., each of the four mixing jets is configured to direct a stream of fluid to impinge upon the axial path for fluid flow at an incidence angle of 90°±5°).

By way of a further example, FIG. 10 illustrates an example jet-mixing reactor that comprises a mixing chamber (102) defining an axial path for fluid flow from an inlet jet (106) to an outlet port (108); and two mixing jets (110) circumferentially disposed about the axial path for fluid flow within the mixing chamber. The two mixing jets is configured to direct a stream of fluid to impinge upon the axial path for fluid flow. The two mixing jets are equally spaced circumferentially about the axial path for fluid flow. Each of mixing jets is configured to direct a stream of fluid to impinge upon the axial path for fluid flow at an incidence angle of 45 degrees.

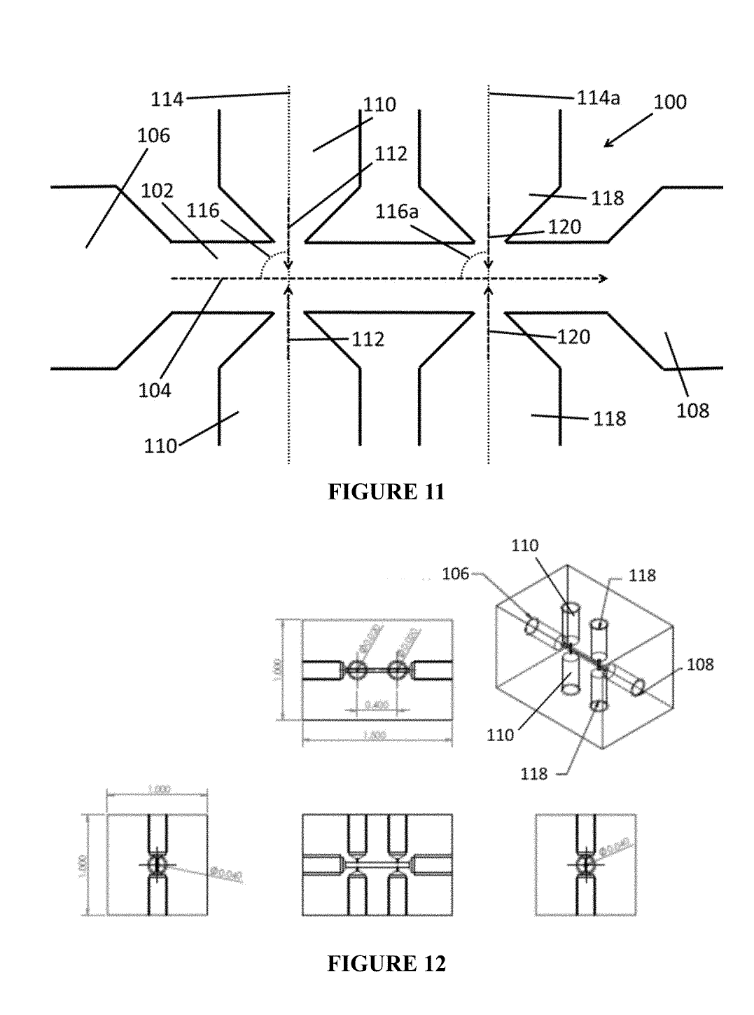

Referring now to FIG. 11, in some embodiments, the reactor (100) can further comprise a second plurality of mixing jets (118) circumferentially disposed about the axial path for fluid flow (104) within the mixing chamber (102). The second plurality of mixing jets (118) can be disposed downstream and axially spaced apart from the first plurality of mixing jets (110). Each of the second plurality of mixing jets can be configured to direct a stream of fluid (120) to impinge upon the axial path for fluid flow.

As with the first plurality of mixing jets, the second plurality of mixing jets can equally spaced circumferentially about the axial path for fluid flow. In some embodiments, the second plurality of mixing jets can be radially spaced from the axial path for fluid flow and disposed within a plane perpendicular to the axial path for fluid flow (114a). Each of the second plurality of mixing jets can be configured to direct a stream of fluid to impinge upon the axial path for fluid flow at an incidence angle (116a) of from 45 degrees to 135 degrees (e.g., from 45 degrees to 90 degrees). In certain embodiments, each of the second plurality of mixing jets can be configured to direct a stream of fluid substantially perpendicular to the axial path for fluid flow (i.e., each of the plurality of mixing jets can be configured to direct a stream of fluid to impinge upon the axial path for fluid flow at an incidence angle of 90°±5°). The second plurality of mixing jets can include any suitable number of mixing jets. For example, the second plurality of mixing jets can comprise from two to eight mixing jets.

By way of example, FIG. 12 illustrates an example jet-mixing reactor that comprises a mixing chamber (102) defining an axial path for fluid flow from an inlet jet (106) to an outlet port (108); a first pair of mixing jets (110) circumferentially disposed about the axial path for fluid flow within the mixing chamber and disposed within a first plane perpendicular to the axial path for fluid flow; and a second pair of mixing jets (118) downstream and axially spaced apart from the first pair of mixing jets and disposed within a second plane perpendicular to the axial path for fluid flow. Each of the mixing jets is configured to direct a stream of fluid to impinge upon the axial path for fluid flow.

By way of non-limiting illustration, examples of certain embodiments of the present disclosure are given below.

### EXAMPLES

A significant challenge for greater utilization of Zeolitic Imidazolate Frameworks (ZIFs) is creating a scalable synthesis method to produce these materials with uniform particle size and high surface areas while achieving high yields. Here, a continuous, solution phase synthesis was demonstrated for ZIF-8 nanoparticles with uniform diameters in the range of 40-80 nm. The synthesis can be achieved using stoichiometric quantities of ligand and metal (i.e., ligand:metal of 2:1) with yields as high as 89% using a jet-mixing reactor. The jet-mixing reactor was studied to determine the effect of different synthesis parameters including ligand to metal ratio, base concentration, and mixing intensity. The base concentration has the most effect on the product size, morphology, and yield. Further, a larger reactor was constructed and tested, demonstrating that the jet-mixing method can be scaled to increase productivity.

Background

Zeolitic imidazolate frameworks (ZIFs) have drawn immense interest in the past decade because these materials are microporous structures with high thermal and chemical stability.

These properties are attractive for many different applications including catalysis, drug delivery, electronic materials, gas storage, sensors, and advanced separations. In particular, ZIFs are thought to have commercial potential in applications for advanced separations such as membrane applications since ZIFs have been demonstrated to help overcome performance limitations of traditional polymeric membranes. For these applications, it can be desirable to produce nanoparticles to limit the effects of diffusion. Currently, research describing continuous manufacturing of ZIFs has been limited, with existing continuous methods producing particles larger than 100 nm and the commercial process producing micron-sized particles (BASOLITE™ Z1200 has D₅₀ of 4.9 μm). At the same time, it can be challenging to produce ZIF nanoparticles with high yields using a sustainable route. The growing importance of ZIFs will be accelerated by the development of continuous, scalable, and sustainable synthesis methods for producing nanoparticles.

ZIF materials can be prepared by various batch synthesis methods. Batch methods typically involve mixing a ligand and metal at a specific ratio in a polar aprotic solvent and heating at high temperatures to generate the microporous product. Batch synthesis has evolved from the original solvothermal synthesis method to new methods, including room temperature syntheses, and many other methods. Room temperature syntheses are highly attractive since these methods are rapid and require minimal amounts of energy. One particular type of room temperature synthesis is called non-solvent induced crystallization (NSIC). In NSIC, the low solubility of ZIF product in protic solvents like methanol is exploited to induce rapid crystallization. NSIC has been studied in great detail to elucidate aspects of the method that affect the particle size, morphology, structure, and composition. The yield and textural properties (surface area and pore volume) of the product obtained from this fairly simple procedure is affected by every component of the synthesis mixture, including the solvent, the type of imidazole ligand, metal salt, and modulating agent/base.

Existing batch methods suffer from several significant limitations. First, conventional batch ZIF synthesis methods produce low yields, ˜50% in most cases. This low utilization of ZIF constituents hampers the efforts to produce ZIFs in a sustainable manner. The second concern is the use of significant excess of ligand for obtaining the desired structure. While the stoichiometry of the reaction requires ligand to metal molar ratio (L:M) of 2:1 (for ZIF-8), most synthetic procedures utilize a L:M ratio of at least 4:1 with modulating agent and up to 70:1 to synthesize ZIFs with ˜50% yield. The excess ligand makes the process expensive, although some work has begun exploring recycling the unconverted ligand.

Efforts to improve the synthesis techniques have evolved over time with the understanding of the crystallization process. An initial approach to reduce the L:M ratio was to add a modulator, in most cases a base. The addition of base helps to maintain a basic pH, driving the assembly of the ligand and metal ion into the final ZIF structure. The most recent development for reducing L:M ratio involved ZIF-8 synthesis with 2:1 L:M ratio in both batch and continuous processes. For the batch processes, two strategies have been employed; incorporation of surfactants and using highly basic conditions. Adding nonionic triblock copolymer (PLURONIC® P-123) as the surfactant enabled ZIF-8 synthesis with reported yields of ˜98%, although recycling the surfactant from the reaction mixture could be a potential challenge for scalable manufacturing of ZIFs using this method. A second approach for stoichiometric synthesis of ZIF-8 involved using 35 wt % aq. ammonia. High yields (>90%) were observed, but it required a 10-fold excess of base. Below this molar composition a dense dia(Zn) structure was observed along with the ZIF-8. Another limitation of these stoichiometric studies is that these syntheses produced 2 μm sized particles. Larger particles can introduce significant diffusion limitations, thus reducing their applicability in adsorption and membrane processes. Overall, these studies indicate that ZIF-8 can be synthesized under stoichiometric conditions, but additional work is required to create a scalable and continuous process.

An advantage of continuous synthesis over batch processes is the ability to control the mixing of the ligand and metal. Mixing becomes an important parameter for fast reactions like ZIF crystallization that can occur in less than a second, especially under flow conditions. Flow crystallization facilitated with rapid mixing has been shown as an effective way to produce uniform nanoparticles for other materials.

Techniques of continuous crystallization, including methods using T-mixers, jet-mixers, and micromixers offer promise for MOF and ZIF synthesis. In particular, flow chemistry offers the potential to improve productivity of the synthetic process while maintaining product quality. In one effort at using flow synthesis to prepare ZIF-8, aqueous solutions of the precursors with L:M ratio 70:1 were mixed using a T-mixer to synthesize 150 nm sized particles. The particle size decreased with an increase in L:M and/or flowrate. The L:M ratio can be reduced to 8:1 using high temperature to produce ZIF-8 nanoparticles (˜100 nm, BET SA: 1830 m²/g). ZIF-8 can also be prepared stoichiometrically in pure methanol using a T-mixer; however, yields are unacceptably low (3-10%). The yield can be increased by switched from methanol to a mixture of concentrated aqueous ammonia in methanol; however, this method produced micron sized aggregates of ZIF particles.

While these mixing methods provide excellent macro scale mixing, more uniform reaction conditions can be achieved through micro scale mixing, which is caused by increasing the mixing intensity of process. Increased mixing intensity can be achieved through utilizing jet-mixing. A jet-mixing reactor utilizes the kinetic energy of introduced impinging jet-streams to generate turbulence in the reactor volume resulting in intense mixing. This makes jet-mixing reactors a promising device for synthesis processes with small reaction time like ZIF crystallization. Such methods can be used to produce uniform ZIF-8 nanoparticles through crystallization at room temperature using stoichiometric precursor concentration and lower concentrations of base. Jet-mixing reactors can be scaled to increase productivity while maintaining high yields. This suggests that rapid mixing methods can be used for the continuous synthesis of nanomaterials, including ZIF-8 nanoparticles, CdSe nanoparticles, CdTe nanoparticles, CNx-type nanomaterials, CIGS nanoparticles, CZTS nanoparticles,

Methods and Materials

The following chemicals were used as received without further purification: zinc nitrate hexahydrate (Zn(NO₃)₂.6H₂O, 98%, Strem Chemicals Inc.), cobalt nitrate hexahydrate (Co(NO₃)₂.6H₂O, 98%, J.T. Baker), 2-methylimidazole (2-mIm, 97%, Alfa Aesar), methanol (MeOH, HPLC grade, Macron fine chemicals), acetone (Fisher chemical, ACS grade), and triethylamine (TEA, 99%, Acros organics).

Unless otherwise noted, the abbreviations used below correspond to the following:

L:M:B=molar ratio of ligand:metal:base used in the reaction mixture

JM=Jet-mixing reactor with dr=0.02″ and dj=0.01″

JM-B=Jet-mixing reactor with dr=0.04″ and dj=0.02″

% yield based on zinc=(Moles of product formed±Moles of zinc added)×100

B=Bulk mixing of precursor solutions

D=Dropwise addition of the precursor solutions

Qr=Flow rate through the main line

Qj=Flow rate through the jet

Reactor Design

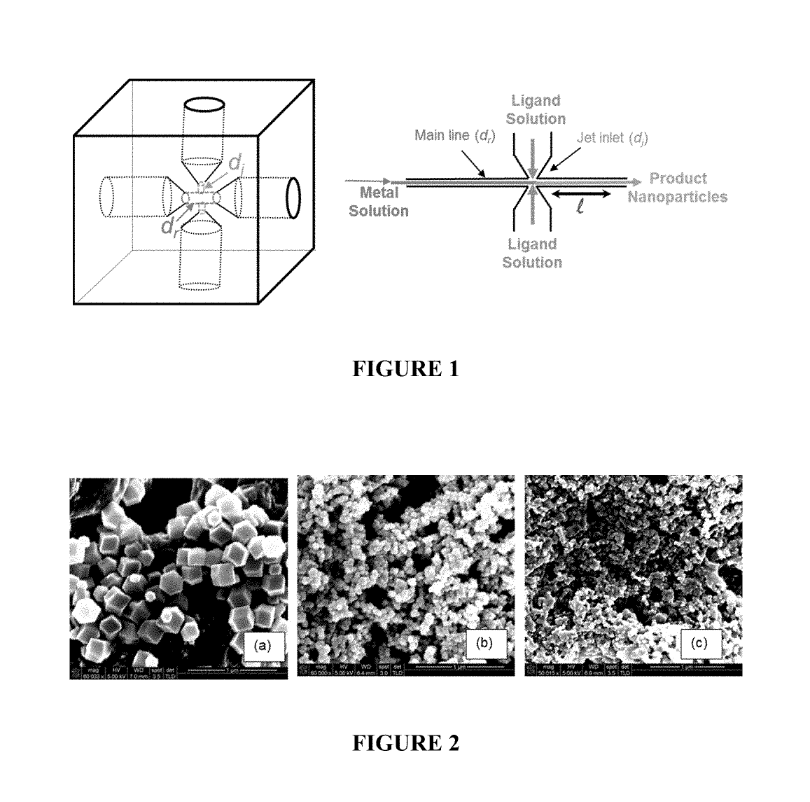

A schematic design of the jet-mixing reactor used in this study is shown in FIG. 1. The jet mixing reactor was built in-house using a 1″×1″×1″ cube of PEEK. It included a main line that had an inlet and outlet port along an axis with diameter dᵣ. The reactor had two jet mixing inlets directed radially inward with diameter dⱼ. The flow through the mixing jets combines with the flow through main line in the center of the device. The test reactor had dimensions of dᵣ=0.02″ (0.5 mm) and jet diameter dⱼ=0.01″ (0.25 mm). The jet-mixing reactor was operated by pumping the metal solution through the main line and introducing the ligand solution through the jets. In the current set-up, two syringe pumps (KD scientific single syringe pump) were used for pumping the precursor solutions to the reactor using 0.03″ ID PEEK tubing. The product was then collected downstream.

The concentrations and flow rates of the precursor solutions can be adjusted to achieve the desired L:M:B ratio in the reactor volume. For instance, doubling the jet flow rate required decreasing the ligand solution concentration by half to maintain the L:M:B. A second reactor with dimensions of dᵣ (0.04″) and dⱼ (0.02″) was also constructed that could operate at higher flow rates of up to ˜50 mL/h (total flow rate). Larger reactors and higher flow rate operations are possible provided that the current syringe pumps are replaced with pumps that can operate at higher flow rates or larger pressure drops (e.g., HPLC pumps).

Synthesis of ZIF-8

For a standard synthesis, metal solution was prepared with 30 mL of 10 mM Zn(NO₃)₂.6H₂O (e.g. 0.0892 g of Zn(NO₃)₂.6H₂O in 30 mL methanol) solution in methanol, and a ligand solution was prepared with 60 mL of 10 mM 2-methylimidazole (mIm) in MeOH (0.0493 g of mIm in 60 mL methanol). The amount of TEA added to ligand solution was varied depending on the desired ligand:metal:base (L:M:B) molar ratio. The metal solution was introduced at a flow rate of Qᵣ through the main line and ligand solution was introduced at a flow rate of Qⱼ is through the jet inlet of the jet-mixing reactor. The product was then collected downstream of the main line in a round bottom flask. The product was aged in the round bottom flask overnight. The collected product was separated by centrifuging the mixture at 7000 RPM for 10 minutes (Beckman Coulter Allegra X-30 centrifuge). The separated solids were then washed with 20 mL methanol twice and dried for 12 hours in an oven set to a temperature of 90° C. For all experiments, the product was aged overnight, but it was observed that identical results could be obtained (i.e., yield and pore volume) if the material was centrifuged immediately after collection. The large number of experiments and numerous variables made creating a naming convention challenging. For simplicity, experiments have been labeled JM-# (e.g., JM-1) to indicate a jet mixing experiment, with bulk addition experiments labeled B-#, and dropwise addition experiments labeled D-#. The conditions for each experiment can be found in Table 1.

TABLE 1
Summary of the synthesis parameters for the different ZIF-8 batches
synthesized in this study. Some experiments were repeated four
times to calculate the standard deviation in the yield.

| | | | | | Flow rate | % yield |
|---|---|---|---|---|---|---|
| | | Zinc | | | (Qᵣ/Qⱼ) | based on |
| Batch | L:M:B | concentration | Solvent | Mixing | mL/h | Zn |
| JM-1 | 2:1:0 | 10 mM | MeOH | JM | 5/10 | 34 |
| JM-2 | 2:1:1 | 10 mM | MeOH | JM | 5/10 | 63 |
| JM-3 | 2:1:2 | 10 mM | MeOH | JM | 5/10 | 78 ± 2 |
| JM-4 | 2:1:2 | 10 mM | MeOH | JM | 10/10 | 84 ± 4 |
| JM-4-0h | 2:1:2 | 10 mM | MeOH | JM | 10/10 | 87 |
| JM-5 | 2:1:2 | 10 mM | MeOH | JM | 10/20 | 80 ± 6 |
| JM-6 | 2:1:2 | 10 mM | MeOH | JM | 10/30 | 78 |
| B-1-0h | 2:1:2 | 10 mM | MeOH | Bulk-addition | — | 86 |
| | | | | with stirring | | |
| D-1-0h | 2:1:2 | 10 mM | MeOH | Dropwise | 10/10 | 86 |
| | | | | addition | | |
| JM-7 | 2:1:2 | 10 mM | Acetone | JM | 10/10 | 76 |
| JM-8 | 4:1:4 | 5 mM | MeOH | JM | 10/20 | 55^{a} |
| JM-9 | 8:1:8 | 5 mM | MeOH | JM | 10/20 | 72^{a} |
| JM-10 | 4:1:4 | 10 mM | MeOH | JM-B | 24/24 | 89 |
| JM-11 | 8:1:8 | 10 mM | MeOH | JM-B | 24/24 | 88 |
| JM-12 | 2:1:2 | 10 mM | MeOH | JM-B | 24/24 | 82 |
| JM-13 | 2:1:2 | 20 mM | MeOH | JM-B | 24/24 | 84 ± 2 |
| JM-14 | 2:1:2 | 50 mM | MeOH | JM-B | 24/24 | 82 |
| JM-15^{b} | 2:1:2 | 20 mM | MeOH | JM-B | 24/24 | 79 |

*^{a}The reactor clogged while the precursor solutions were being pumped.
*^{b}JM-15 represents the ZIF-67 sample

Materials Characterization

The materials were characterized using a battery of standard techniques, including powder X-ray diffraction (XRD), nitrogen physisorption, and scanning electron microscopy (SEM). For XRD, the measurement was performed using a Bruker D8 Advance X-ray powder diffractometer. The diffraction data was collected in standard reflection mode using monochromatic Cu Kₐ₁ radiation (λ=1.54 Å) at 40 kV and 50 mA. The sample was dispersed in methanol and then deposited as a thin layer on the sample holder because of the limited quantity of the product. In some cases, an amorphous hump was observed in the XRD spectrum, which could be attributed to the background glass slide. The textural properties of the material were characterized using a Micromeritics 3Flex surface characterization analyzer.

The samples were first degassed on Micromeritics SmartVacPrep sample preparation device at 90° C. under vacuum (1×10⁻⁵ mmHg) for 8 h followed by in-situ degassing of samples on the 3Flex instrument for 4 h at 90° C. under vacuum (5×10⁻⁵ mmHg). The nitrogen sorption isotherms of degassed samples were recorded at liquid nitrogen temperatures (˜77 K). The materials were further analyzed using a FEI Quanta 200 SEM to determine particle size and morphology. Samples were prepared for SEM by spin coating the reaction mixture (suspension) before centrifuging. The samples were spin coated onto a carbon conductive tab through adding 200 μL of the sample mixture while the carbon tape was spinning at 3000 RPM. The 200 μL sample was deposited in approximately 10 seconds, but the sample was allowed to continue spinning for a total of 2 min. The spin-coated samples were sputtered at 17 mA for 60 s with gold-palladium alloy using a Cressington 108 Sputter coater before analysis.

Results and Discussion

Initial experiments demonstrate that the jet mixing technique successfully produces ZIF-8 with high yields over a range of conditions. The initial conditions studied (JM-1) used a stoichiometric ratio of ligand to metal without any base (L:M:B=2:1:0). The metal solution (10 mM) was pumped at 5 mL/h through main line of JM reactor and ligand solution (10 mM) was introduced at 10 mL/h through the jets. Using these conditions, pure ZIF-8 was synthesized with 34% yield based on Zn. This yield was considerable since the remaining ligand in the synthesis serves to neutralize the nitric acid generated in the synthesis. The XRD and nitrogen physisorption data confirmed the high crystallinity of ZIF-8, with Langmuir surface area 2860 m²/g and t-plot pore volume 0.42 cm³/g. SEM imaging showed that the particles were 255±62 nm in size and exhibited a rhombic dodecahedron morphology.

With the successful synthesis of ZIF-8, the remainder of this work focused on studying the effect on synthesis yield, material quality, and particle size for several parameters, including the base concentration, the effect of the L:M, the concentrations, flow rates, and type of solvent. All materials were characterized using XRD, nitrogen physisorption, and SEM to compare the properties to the values reported in literature. Tables 1-8 summarize the results of different syntheses done for investigating the effect of synthesis parameters on yield and properties of the product.

TABLE 2
Comparison of properties of ZIF-8 synthesized under different base
concentration, keeping the other parameters constant: JM reactor -
0.01″/0.02″, Qr/Qj = 5/10 mL/h, and 10 mM Zn concentration.

| | | | Surface area | Pore volume |
|---|---|---|---|---|
| Experiment | L:M:B | % Yield | (m²/g) | (cm³/g) |
| JM-1 | 2:1:0 | 34 | 2860 | 0.415 |
| JM-2 | 2:1:1 | 63 | 1944 | 0.267 |
| JM-3 | 2:1:2 | 78 ± 2 | 1802 | 0.560 |

TABLE 3
Comparison of properties of ZIF-8 synthesized under different
mixing conditions, keeping the other parameters constant: L:M:B =
2:1:2, Qr/Qj = 10/10 mL/h, and 10 mM Zn concentration.

| | | | Surface area | Pore volume |
|---|---|---|---|---|
| Experiment | Mixing | % Yield | (m²/g) | (cm³/g) |
| JM-4-0h | Jet-mixing | 87 | 2511 | 0.635 |
| D-1-0h | Dropwise addition | 86 | 1969 | 0.577 |
| B-1-0h | Bulk addition with | 86 | 2851 | 0.606 |
| | stirring | | | |

TABLE 4
Comparison of properties of ZIF-8 synthesized under different flow
rates (Qj/Qr), keeping the other parameters constant: L:M:B =
2:1:2,10 mM Zn concentration, and JM reactor - 0.01″/0.02″.

| | | | Surface area | Pore volume |
|---|---|---|---|---|
| Experiment | Qⱼ/Qᵣ, mL/h | % Yield | (m²/g) | (cm³/g) |
| JM-4 | 10/10 | 84 ± 4 | 1807 | 0.507 |
| JM-5 | 10/20 | 80 ± 6 | 2150 | 0.452 |
| JM-6 | 10/30 | 78 | 1782 | 0.533 |

TABLE 5
Comparison of properties of ZIF-8 synthesized using
different solvents, keeping the other parameters
constant: L:M:B = 2:1:2, Qr/Qj = 10/10
mL/h, JM reactor - 0.01″/0.02″, and 10 mM Zn concentration.

| | | | Surface area | Pore volume |
|---|---|---|---|---|
| Experiment | Solvent | % Yield | (m²/g) | (cm³/g) |
| JM-4 | Methanol | 84 ± 4 | 1807 | 0.507 |
| JM-7 | Acetone | 76 | 2007 | 0.392 |

TABLE 6
Comparison of properties of ZIF-8 synthesized
using different L:M:B ratios.
(a) Small JM reactor: JM reactor - 0.01″/0.02″, Qr/Qj =
10/20 mL/h, and 5 mM Zn concentration.

| Experiment | L:M:B | % Yield |
|---|---|---|
| JM-8 | 4:1:4 | 55 |
| JM-9 | 8:1:8 | 72 |

(b) Larger JM reactor: JM reactor - 0.02″/0.04″, Qr/Qj =
24/24 mL/h, and 10 mM Zn concentration.

| | | | Surface area | Pore volume |
|---|---|---|---|---|
| Experiment | L:M:B | % Yield | (m²/g) | (cm³/g) |
| JM-12 | 2:1:2 | 82 | 2257 | 0.513 |
| JM-10 | 4:1:4 | 89 | 2109 | 0.394 |
| JM-11 | 8:1:8 | 88 | 2619 | 0.354 |

TABLE 7
Comparison of properties of ZIF-8 synthesized using
different reactor size, keeping the other parameteres
constant: L:M:B = 2:1:2 and 10 mM Zn concentration.

| Experiment | JM reactor | Qⱼ/Qᵣ mL/h | % Yield |
|---|---|---|---|
| JM-4 | 0.01″/0.02″ | 10/10 | 84 ± 4 |
| JM-12 | 0.02″/0.04″ | 24/24 | 82 |

TABLE 8
Comparison of properties of ZIF-8 synthesized using different precursor
concentrations, keeping the other parameters constant: L:M:B =
2:1:2, Qr/Qj = 24/24 mL/h, and JM reactor - 0.02″/0.04″.

| | Zn | | Surface area | Pore volume |
|---|---|---|---|---|
| Experiment | Concentration | % Yield | (m²/g) | (cm³/g) |
| JM-12 | 10 mM | 82 | 2257 | 0.513 |
| JM-13 | 20 mM | 84 ± 2 | 2359 | 0.497 |
| JM-14 | 50 mM | 82 | 2419 | 0.427 |

Effect of Base Concentration

The effect of base concentration was studied through systematically varying the base concentration while keeping the L:M=2:1. It was observed that the yield increased with an increase in base concentration. The increase in yield with increased base concentration was attributed to neutralization of the nitric acid formed during the reaction. The comparison of product properties with increase in base concentration can be seen from Table 9. The samples displayed a high surface area and pore volume consistent with a high quality of synthesized material, except for JM-2 where an unusually low pore volume was observed. The surface area of the material decreased with increasing base concentration. These values for the textural properties of the material were consistent with the highest quality materials synthesized using batch conditions. Overall, higher yields were observed for jet-mixing than for other synthesis techniques that employ identical conditions. Unless otherwise noted, it can be assumed that the textural properties were similar for all the samples synthesized in this report.

TABLE 9
Comparison of ZIF-8 properties with increasing base concentration
for JM synthesis. % yield values are based on limiting reactant Zn.

| | | | Langmuir | H - K |
|---|---|---|---|---|
| | L:M:B | | surface area | pore volume |
| Experiment | (molar ratio) | % yield | (m²/g) | (cm³/g) |
| JM-1 | 2:1:0 | 34 | 2860 | 0.42 |
| JM-2 | 2:1:1 | 63 | 1944 | 0.27 |
| JM-3 | 2:1:2 | 78 ± 2 | 1802 | 0.56 |

The particle size and morphology were investigated using SEM. FIG. 2 shows the SEM images of ZIF-8 product synthesized using different base concentration. It is observed that the morphology was dependent on the presence or absence of base. In the absence of base, rhombic dodecahedron particles were formed whereas in presence of base rounded berry-like particles were observed. The berry-like morphology has been reported for a very few cases for ZIF-8.

The base also affects the particle size. Adding base caused a sharp decrease in particle size and narrowed the particle size distribution; from 255±62 nm in absence of base (JM-1) to 63±9 nm for L:M:B of 2:1:1 (JM-2). Interestingly, increasing the base concentration up to a L:M:B of 2:1:2 only decreased the particle size slightly. These results suggest that addition of the base concentration drastically increases the rate of nucleation, reducing the particle size (JM-2). A further increase in base concentration (JM-3) only slightly changed the nucleation rate, but the increase in base concentration did increase the overall yield to 78±2%. Overall, the reported yields are highly reproducible, representing the average of four experiments.

Effect of Mixing

The jet-mixing reactor enabled investigations into the effect of mixing intensity on the final product. Two potential ways that can impact the mixing within the reaction volume are increasing the main line flow rate (Qᵣ) and increasing the jet flow rate (Qⱼ). Increasing Qⱼ will increase the mixing intensity through increasing the kinetic energy added to the mixing volume while increasing Qᵣ reduces the residence time in the reactor. First, Qᵣ was increased from 5 mL/h to 10 mL/h while keeping the jet flow rate (Qⱼ) 10 mL/h and L:M:B ratio as 2:1:2. ZIF-8 was synthesized with yield of ˜84±4% on the basis of zinc used (JM-4). While increasing the flow rates increased the yield, it also resulted in an increase in the particle size to 74±15 nm. The increased particle size was expected as the amount of energy input per unit volume of the reaction volume decreased, which in turn reduces the mixing intensity. To confirm that increase in yield was not caused by the aging process, for JM-4-0h the material was separated immediately after the pumping was complete. It was observed that pure ZIF-8 phase was synthesized with 87% yield even without the aging process.

The flow rate ratio (Qⱼ/Qᵣ) was systematically increased from 1 to 3 (Table 4: JM-4, JM-5, and JM-6) to investigate the effect of increasing the energy introduced per unit volume in the JM reactor while keeping the L:M:B of 2:1:2. In all three cases, pure ZIF-8 phase was synthesized with very similar yield ˜80%. This result suggests that for the current set-up the Qⱼ/Qᵣ of 1 provides sufficient mixing for generating uniform reaction mixture within the reactor volume.

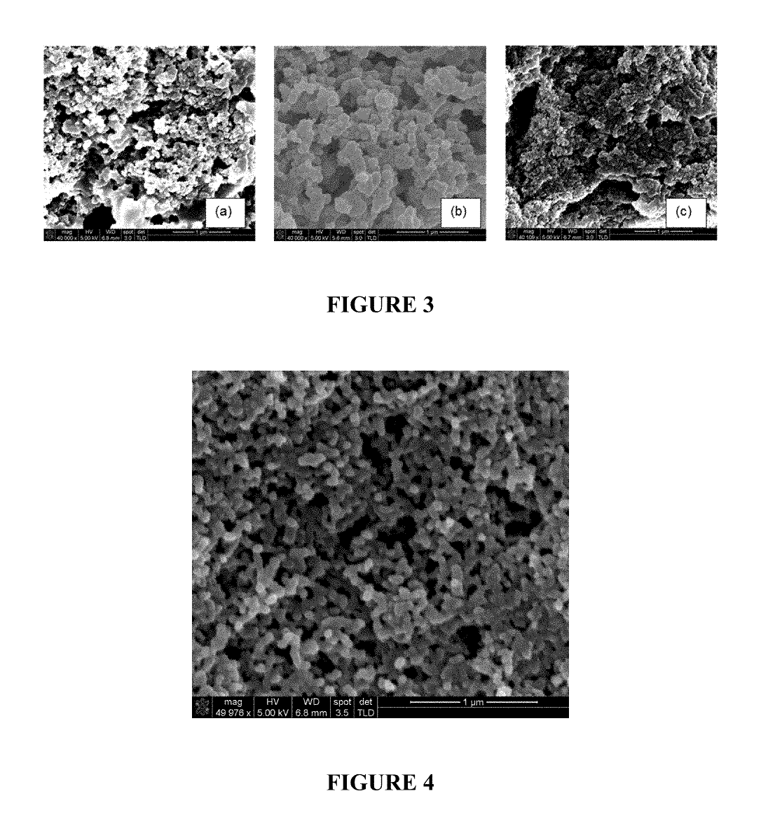

The mixing intensity was further investigated through comparing product properties of: (1) ZIF-8 synthesized using jet-mixing reactor (JM-4-0h), (2) ZIF-8 synthesized by dropwise addition (D-1-0h), and (3) bulk addition (B-1-0h) of the precursor solutions (Table 3). For the drop wise addition method, the precursor solutions were added dropwise to the collection flask whereas in bulk addition the metal solution was poured in to the ligand solution. Both bulk mixing (B-1-0h) and dropwise addition (D-1-0h) of precursor solutions at 2:1 L:M ratio yielded highly crystalline ZIF-8 (FIG. 3). Interestingly, it was observed that the mixing intensity greatly affects the particle size and particle size distribution of the product (FIG. 3). With the decrease in mixing intensity, the particle size and aggregation increased. JM resulted in the formation of rounded particles (74±15 nm) whereas drop wise mixing produced a broader size distribution of larger particles (104±43 nm). Bulk addition formed more agglomerated structures. Particle size analysis was not feasible for bulk addition product because of the agglomeration. These observations suggest that the particle size can be controlled by controlling the mixing intensity within the reaction volume.

Effect of Solvent

Controlling particle size was an important factor for ZIF synthesis, more specifically for membrane applications. While methanol was the primary solvent used for ZIF-8 synthesis, changing the solvent to acetone resulted in 60±15 nm particles of ZIF-8 with 76% yield (JM-7 BET SA: 2007 m²/g, Pore volume: 0.39 cm³/g). See FIG. 4. These particles were smaller than ZIF-8 synthesized in methanol (JM-4, 74±15 nm). This suggests that the solvent selection can be an important factor to control particle size.

Effect of L:M, L:M:B, and Absolute Concentration

Particle size was also controlled by increasing nucleation by increasing the ligand to metal ratio (L:M). The effect of increasing L:M ratio above stoichiometric requirement was investigated for L:M:B of 4:1:4 and 8:1:8 (keeping L:TEA=1:1). With 10 mM Zn(NO₃)₂.6H₂O, increasing the L:M ratio caused severe clogging of reactor, suggesting rapid nucleation. To avoid clogging the reactor, two approaches are tested: (1) reducing the concentration to 5 mM Zn(NO₃)₂.6H₂O for higher L:M (Table 6 (a) JM-8 and JM-9) and (2) using a larger reactor while keeping the Zn(NO₃)₂.6H₂O concentration 10 mM (Table 6 (b) JM-10 and JM-11). While both approaches resulted in the formation of crystalline ZIF-8, the scaled up reactor results in increased yields (˜90%). The higher yields can be partially attributed to increased collection efficiency from centrifugation process as more quantity of product was synthesized when using the larger reactor. Increasing the L:M ratio increased the particle aggregation, and resulted in the formation of mesopores indicated by a hysteresis in the nitrogen physisorption analysis.

With the higher concentrations and bigger reactor geometry, the productivity also increased from ˜0.02 g/h (JM-4) for 2:1:2 L:M:B ratio with the small reactor to ˜0.04 g/h (JM-12) with the larger scale reactor based on the pumping time. Productivity of the process could be further increased by using a higher concentration of the precursors. The effect of absolute precursor concentration was compared by using 10 mM (JM-12), 20 mM (JM-13), and 50 mM (JM-14) metal solution and 2:1:2 L:M:B for the big jet-mixing reactor (Table 8). In all three cases, pure ZIF-8 was synthesized with greater than 80% yield. Using higher precursor concentration resulted in increased surface area with decrease in the micropore volume, with formation of mesopores in case of JM-14. At concentrations higher than 50 mM, reactor clogging caused by rapid crystallization, agglomeration, and precipitation prevented any further increase in productivity. To overcome this limitation, the flow rates could be increased; however, this is limited by pressure drop in the system. Therefore, using the current jet mixing reactors, a 50 mM metal solution was the highest concentration used. This afforded a maximum productivity of 0.19 g/h. Further increases in productivity can be achieved by, for example, increasing the reactor size and/or increasing the flow rates.

Synthesis of ZIF-67

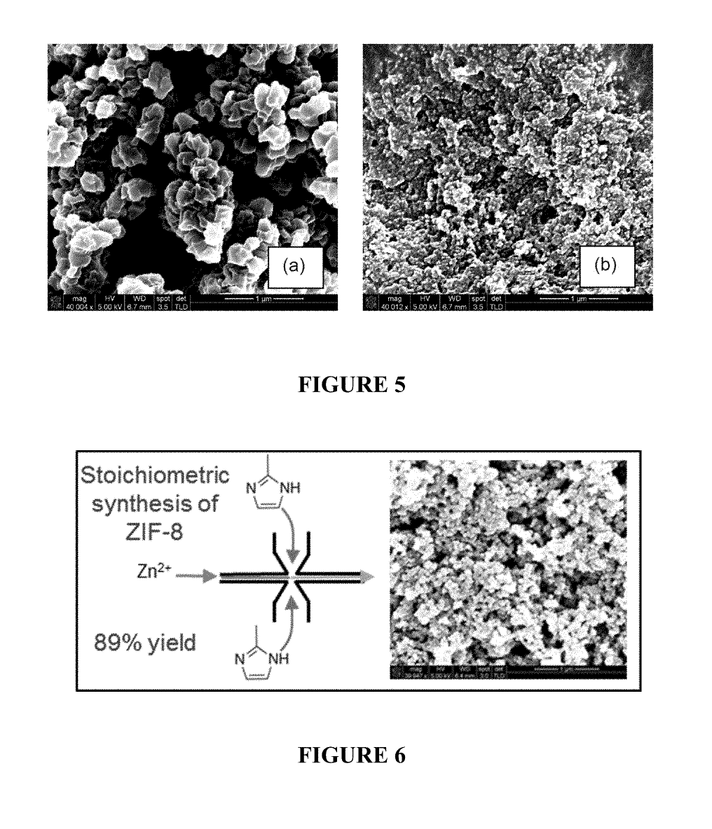

The jet-mixing reactor is versatile and can be used for synthesizing nanomaterials, including other ZIFs. To demonstrate this, ZIF-67 was synthesized with 79% yield (based on cobalt) using methanolic solution of Co(NO₃).6H₂O and 2-mIm with L:M:B ratio of 2:1:2 using the same conditions as JM-13. The sample had a Langmuir surface area of 1817.17 m²/g and pore volume of 0.53 cm³/g, consistent with literature values. SEM analysis of the product shows aggregation of particles resulting in a broad particle size distribution with average particle size of 215±90 nm. These particles are bigger and more aggregated than the ZIF-8 (JM-13) synthesized under similar conditions (FIG. 5). The observed differences reflect the differences in ZIF-67 crystallization, and conditions could likely be tuned to target different particle sizes. Overall, these results confirm the versatility of the jet-mixing reactor for nanoparticle synthesis.

### CONCLUSION

ZIF-8 was synthesized with up to 89% yield under stoichiometric precursor concentrations using a jet-mixing reactor set-up. The effect of different synthesis parameters including L:M ratio, base concentration, solvent, and mixing was evaluated. Addition of base increased the rate of nucleation, thus resulting in smaller particles. For most materials, the surface area and pore volume of the jet-mixing products was comparable to the reported values of high quality material in literature. Interestingly, jet-mixing resulted in a narrow particle size distribution of product with formation of 60-80 nm sized particles. These results demonstrate that under rapid mixing conditions, ZIF-8 can be synthesized without adding excess ligand; thus making the process more sustainable. The jet-mixing set-up presented in this work can be used to synthesize other ZIFs was well as other nanomaterials with controlled particle size and morphology.

The devices, systems, and methods of the appended claims are not limited in scope by the specific devices, systems, and methods described herein, which are intended as illustrations of a few aspects of the claims. Any devices, systems, and methods that are functionally equivalent are intended to fall within the scope of the claims. Various modifications of the devices, systems, and methods in addition to those shown and described herein are intended to fall within the scope of the appended claims. Further, while only certain representative devices, systems, and method steps disclosed herein are specifically described, other combinations of the devices, systems, and method steps also are intended to fall within the scope of the appended claims, even if not specifically recited. Thus, a combination of steps, elements, components, or constituents may be explicitly mentioned herein or less, however, other combinations of steps, elements, components, and constituents are included, even though not explicitly stated.

The term “comprising” and variations thereof as used herein is used synonymously with the term “including” and variations thereof and are open, non-limiting terms. Although the terms “comprising” and “including” have been used herein to describe various embodiments, the terms “consisting essentially of” and “consisting of” can be used in place of “comprising” and “including” to provide for more specific embodiments of the invention and are also disclosed. Other than where noted, all numbers expressing geometries, dimensions, and so forth used in the specification and claims are to be understood at the very least, and not as an attempt to limit the application of the doctrine of equivalents to the scope of the claims, to be construed in light of the number of significant digits and ordinary rounding approaches.

Unless defined otherwise, all technical and scientific terms used herein have the same meanings as commonly understood by one of skill in the art to which the disclosed invention belongs. Publications cited herein and the materials for which they are cited are specifically incorporated by reference.

What is claimed is:

1. A method for preparing a population of nanoparticles, the method comprising:
directing a stream of a first precursor solution through a mixing chamber, wherein the stream flows through a mixing chamber along an axis of fluid flow stretching from an inlet jet to an outlet port; and
directing a plurality of mixing streams to impinge upon the stream of the first precursor solution within the mixing chamber, wherein each of the plurality of mixing streams comprises a second precursor solution, thereby mixing the first precursor solution and the second precursor solution to form the population of nanoparticles.

2. The method of claim 1, wherein each of the plurality of mixing streams is directed from a mixing jet.

3. The method of claim 2, wherein the mixing jets are circumferentially disposed about the axis of fluid flow.

4. The method of claim 3, wherein the mixing jets are equally spaced circumferentially about the axis of fluid flow.

5. The method of claim 2, wherein the mixing jets are radially spaced from the stream of the first precursor solution and disposed within a plane perpendicular to the axis of fluid flow.

6. The method of claim 1, wherein the plurality of mixing streams impinge upon the stream of the first precursor solution at an incidence angle of from 45 degrees to 135 degrees.

7. The method of claim 1, wherein the plurality of mixing streams impinge upon the stream of the first precursor solution at an incidence angle of from 45 degrees to 90 degrees.

8. The method of claim 1, wherein the plurality of mixing streams are directed substantially perpendicular to the stream of the first precursor solution.

9. The method of claim 1, wherein the plurality of mixing streams comprises from two to eight mixing streams.

10. The method of claim 1, wherein the mixing of the first precursor solution and the second precursor solution comprises turbulent mixing.

11. The method of claim 10, wherein the mixing of the first precursor solution and the second precursor solution comprises mixing at a Reynolds number of at least 2000.

12. The method of claim 1, further comprising directing a second plurality of mixing streams to impinge upon the stream of the first precursor solution and second precursor solution within the mixing chamber.

13. The method of claim 12, wherein each of the second plurality of mixing streams comprises a third precursor solution.

14. The method of claim 12, wherein each of the second plurality of mixing streams comprises a solvent.

15. The method of claim 1, wherein the first precursor solution comprises a metal salt.

16. The method of claim 1, wherein the second precursor solution comprises a metal salt, ligand, or a combination thereof.

17. The method of claim 1, wherein the population of nanoparticles comprises nanoparticles formed from a metal organic framework (MOF).

18. The method of claim 1, wherein the population of nanoparticles has an average particle size of less than 100 nm.

19. The method of claim 1, wherein the population of nanoparticles is monodisperse.

20. A jet-mixing reactor for the preparation of nanoparticles comprising
a mixing chamber defining an axial path for fluid flow from an inlet jet to an outlet port; and
a plurality of mixing jets circumferentially disposed about the axial path for fluid flow within the mixing chamber,
wherein each of the plurality of mixing jets is configured to direct a stream of fluid to impinge upon the axial path for fluid flow.
